(19) United States
(12) Patent Application Publication
(10) Pub. No.: US 2012/0180385 A1
(43) Pub. Date: Jul. 19, 2012

(54) PLANT PILLOW

(76) Inventor: Thomas DeHaven, Bend, OR (US)

(21) Appl. No.: 13/008,397

(22) Filed: Jan. 18, 2011

(51) Int. Cl. A01G 9/14; A01G 13/02

(52) U.S. Cl. 47/17

(57) ABSTRACT

A plant pillow for protecting a seed or plant from cold. The plant pillow includes an upper pyramid, a base for supporting that pyramid, and a bladder for holding water. The pyramid forms a greenhouse that uses solar energy to heat water in the bladder. When the bladder is placed around a seed or plant the bladder transfers heat from the solar heated water to the ground to protect the seen or plant against cold. The sides of the pyramid are attached to the base via flexible transitions that allow the sides to be lowered to allow access inside the pyramid. A filler inside the pyramid allows water to be added to the bladder.

### FIELD OF THE INVENTION

The presently disclosed subject matter is directed towards an apparatus for protecting germinating seeds and young plants from cold damage.

### BACKGROUND OF THE INVENTION

Germination refers to the growth process of a mature seed into a plant. Seed germination is characterized by the emergence of a stem and root system that supply a plant with water and nutrients. Proper plant germination depends on a seed having suitable conditions for germination, such as an appropriate soil, sufficient but not excessive water, acceptable temperatures, correct sunlight, and proper soil nutrients.

While a gardener can assist germination by planting seeds at the correct time of the year in appropriate soil having the correct nutrients, and while a gardener can ensure sufficient amounts of water by providing for irrigation, a gardener has little control on temperatures. Even if a seed is planted at the correct time of the year a cold spell can result in serious damage to germinating seeds and young plants.

A prior art method of protecting germinating seeds and young plants against cold is to germinate seeds in a greenhouse and then transfer the young plants to a suitable field when the danger of cold damage has past. While that method has proven highly successful it can be an excessively costly approach for home gardeners and many others. Furthermore, transferring plants from a greenhouse to a field can itself damage young plants.

Another known method of protecting germinating seeds and young plants against cold is to use area wide heaters in a field. For example, propane or nature powered gas heaters can be used in a field to heat the ground and protect germinating seeds and young plants. However, the cost of the heaters and the fuel to operate them can be prohibitive.

Therefore, a technique of protecting germinating seeds and young plants in a field would be beneficial. Even more beneficial would be a technique of protecting germinating seeds and young plants in the ground without requiring fuel.

### BRIEF SUMMARY OF THE INVENTION

The principles of the present invention provide for a technique of protecting germinating seeds and young plants in a field without requiring gas fired area wide heaters. Those principles are incorporated in a plant pillow comprised of an upper pyramid, a base for supporting the pyramid, flexible transitions for connecting the sides of the pyramid to the base, and a bladder for holding water. The base includes a filler that allows water to be added to the bladder. The pyramid forms a greenhouse that uses solar energy to heat the water in the bladder. When the bladder is placed around a seed or plant the bladder transfers heat from the solar heated water to the ground to protect the seen or plant against cold.

### BRIEF DESCRIPTION OF THE DRAWINGS

The advantages and features of the present invention will become better understood with reference to the following detailed description and claims when taken in conjunction with the accompanying drawings, in which like elements are identified with like symbols, and in which:

FIG. 1 is a perspective view of a pyramid-shaped plant pillow 10 that is in accord with a preferred embodiment of the present invention;

FIG. 2A is a perspective view of the plant pillow 10 wherein one (1) side of a pyramid 20 is depicted in an open state;

FIG. 3A is a perspective view of a first tab 16a and a second tab 16b of the plant pillow 10 when they are in a pre-assembly alignment state;

FIG. 3B is a perspective view of the first tab 16a and the second tab 16b of FIG. 3A in an interlocked state;

FIG. 4A is a perspective top view of a water container 30 and its integral panes 14 of the plant pillow 10 according to a preferred embodiment of the present invention;

FIG. 4B is a perspective view of a first alternate filler 40 according to a first alternate embodiment of the present invention;

FIG. 4C is a perspective view of a second alternate filler 50 according to a second alternate embodiment of the present invention;

FIG. 4D is a perspective view of a third alternate filler 60 filler according to a third alternate embodiment of the present invention;

FIG. 4E is a perspective view of a fourth alternate filler 70 depicted in an open state, according to a fourth alternate embodiment of the present invention; and,

FIG. 4F is a perspective view of the fourth alternate filler 70 depicted in a closed state according.

### DETAILED DESCRIPTION OF THE INVENTION

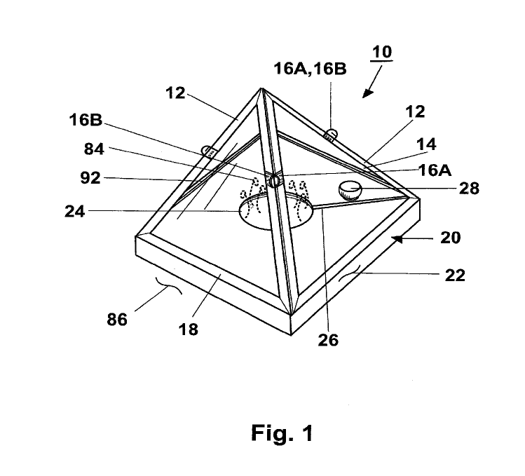

Preferred embodiments for carrying out the principles of the present invention are described herein with reference to FIGS. 1 through 4F. However, the present invention is not limited to the specifically described and illustrated embodiments. A person skilled in the art will appreciate that many other embodiments are possible without deviating from the basic concept of the invention. Therefore, the principles of the present invention extend to any work that falls within the scope of the appended claims.

As used herein, the terms “a” and “an” herein do not denote a limitation of quantity, but rather denote the presence of at least one of the referenced items.

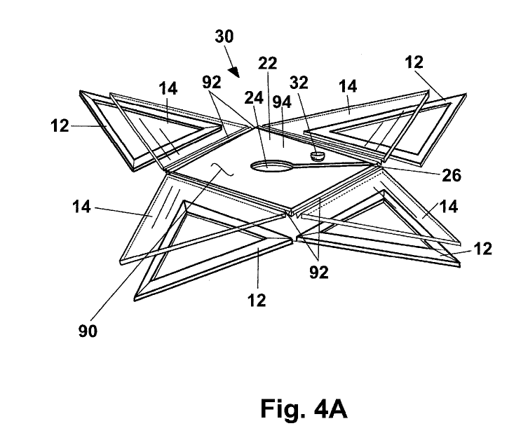

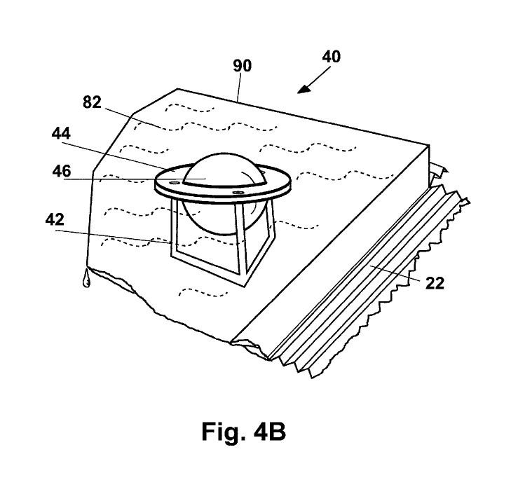

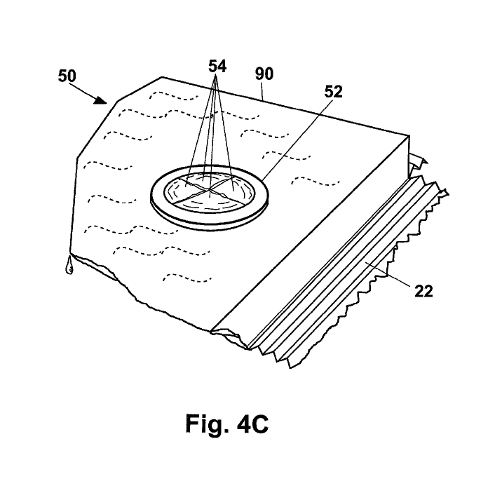

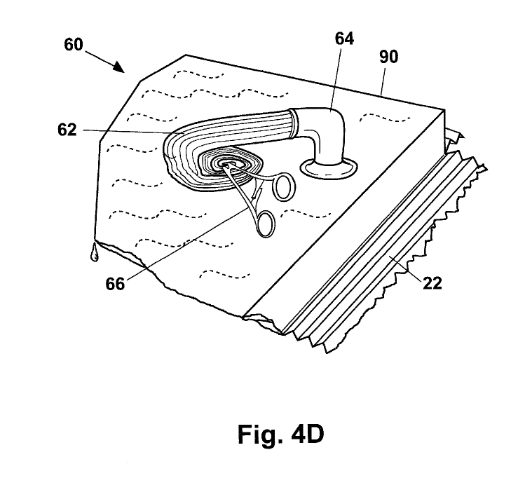

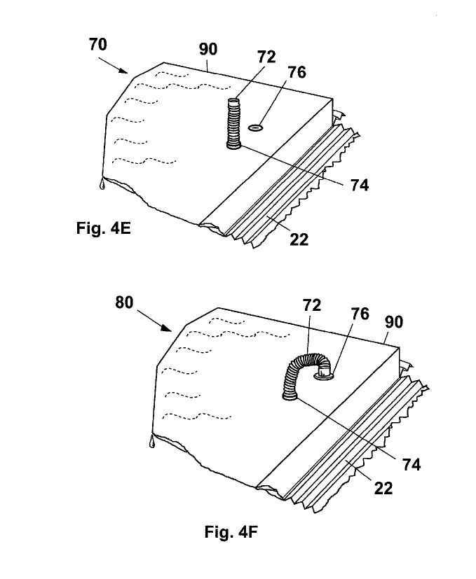

Referring now to FIGS. 1 and 4A, the principles of the present invention relate to a pyramid shaped plant pillow 10 comprising an upper pyramid 20, a square base 90, and a lower water containing bladder 22. The plant pillow 10 provides a controlled and protective growing environment for plants 84 in the ground 86 which are protected by the plant pillow 10.

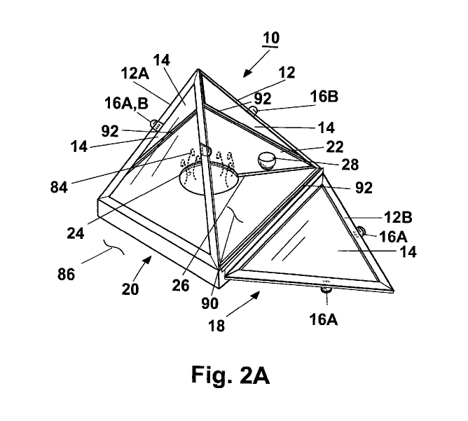

Referring now to FIGS. 1, 2A the pyramid 20 is formed by a plurality of identically shaped triangular side panels 18. While the illustrated embodiments have four side panels 18, that is not a requirement. Since a pyramid is a structure where the outer surfaces (the side panels 18) are triangular, and while at least three panels are required, other numbers of side panels can be used.

Each side panel 18 has a rigid frame comprised of an external triangular frame 12a, an internal triangular frame 12b, and a transparent pane 14, the outer edges of which are sandwiched between the external triangular frame 12a and the internal triangular frame 12b. The external frame 12a, the edges of the pane 14, and the internal frame 12b are permanently fastened together, such as by welding or chemical bonding, to form the side panel 18.

Referring now to FIGS. 2A and 4A, each side panel 18 of the pyramid 20 attaches to a different edge of the square base 90 via flexible transitions 92. Beneficially, the square base 90, the integral flexible transitions 92, and the panes 14 are all made of clear or translucent polymeric material.

As shown in FIGS. 1, 2A, and 4A, the square base 90 includes both a central aperture 24 and a slit 26. The slit 26 extends from the central aperture 24 to a corner of the square base 90 where two side panels 18 meet. The slit 26 allows the sides of the square base 90 to slightly separate. That separation allows the plant pillow 10 to be placed around or removed from a plant 84 if that plant obstructs simply placing or lifting off the plant pillow 10 from the ground 86.

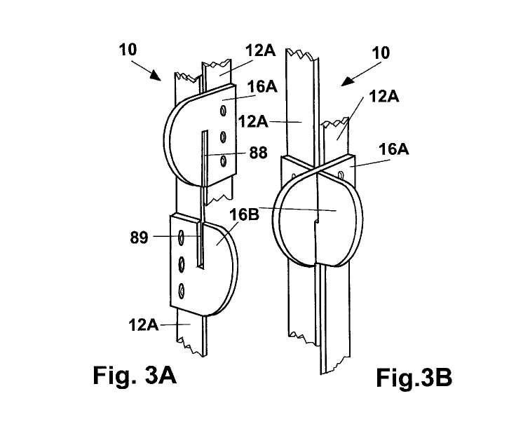

Referring now to FIGS. 1, 2A, 3A, and 3B, on adjacent edges of the outer frames 12a of adjacent side panels 18 are a first tab 16a and a second tab 16b. As shown in FIGS. 3A and 3B, each first tab 16a includes a downward facing slot 88 while each second tab 16b includes an upward facing slot 89. Still referring to FIGS. 3A and 3B, each downward facing slot 88 interlocks with a mating upward facing slot 89 so as to fasten adjacent side panels together. This interlocking action, together with the rigidness of the various components, secures the shape of the pyramid 20.

When the tabs 16s and 16b are all interlocked the pyramid 20 and the square base 90 form a rigid structure that can withstand both handling and the elements. To assist this, the tabs 16a and 16b should be located in positions such that their interlocking location is above the horizontal center line of the side panels 18. This optimizes the stability of the adjoining side panels 18 while securing the shape of the pyramid 20.

The tabs 16a and 16b are beneficially comprised of plastic or aluminum and are permanently fastened onto a front portion of the outer frames 12a. Chemical bonding, welding, or riveting are among the suitable methods of attaching the tabs 16a and 16b to the outer frames 12a.

While the pyramid 20 uses the tabs 16a and 16b to retain the side panels 18 in position, alternative means of fastening the side panels 18 onto each other are envisioned. Such alternative means include, but are not limited to hook-and-loop strips, loose-pin hinges, fabric strips, and snaps.

FIG. 2A illustrates a perspective view of the plant pillow 10 when a side panel 18 is opened. The opened side panel 18 provides a means to access the plant 84 within the pyramid 20 or to allow the plant 84 to become acclimatized to external conditions.

Turning now back to FIG. 1, the bladder 22 is formed by peripherally welding or heat sealing a flexible, water-proof material, such as rubber, to the bottom of the square base 90. The bladder 22 and the square base 90 form a water tight structure for holding water 82. However, the bladder 22 is not a continuous piece. Rather, it surrounds most of the aperture 24 of the square base 90. Furthermore, the bladder 22 is configured so that it does not extend across the slit 26. These features allow the bladder 22 to sit on the ground 86, surround the plant 84, and to be removed from a seed or the plant 84 when the plant 84 has sufficiently grown.

As noted the bladder 22 and the square portion retain water. To that end the square base 90 incorporates a threaded filler neck 32 (shown in FIG. 4 A) which is sealed by a mating cap 28 (shown in FIGS. 1, 2 A). The filler neck 32 can be either formed along with the square base 90 or it can be added by chemical bonding or welding the filler neck 32 onto the square portion 94. In either event, passing through the filler neck 32 fills the bladder 22.

Turning now to FIG. 1, in operation a seed or a plant 84 is planted in the ground 86. The plant pillow 10 is placed over the seed or plant 84 such that the aperture 24 aligns with the seed or plant 84. This allows the seed or plant 84 to grow up through the aperture and into the plant pillow. The bladder 22 is configured to provide a growing space for the plant 84. Water 82 is added to the bladder 22 through the filler neck 32. When the bladder 22 is full the mating cap 28 is screwed onto the filler neck 32 to prevent water leakage.

The plant pillow 10 acts as a greenhouse. Solar energy warms the pyramid 20, which causes heat to pass though the square base 90 into the water in the bladder 22. The warmed water then transfers heat into the ground, which protects the seed or young plant 84 from cold damage. The temperature moderating effect of the plant pillow 10 provides a growth promoting stable environment. It is envisioned that the bladder 22 can be filled with warm water 82 and solar energy and the greenhouse effect will enable a moderating temperature range to be maintained. It is further envisioned that the bladder 22 portion can be tinted in various colors, thereby providing a selection of desired levels of reflectivity and emissivity of solar energy.

The foregoing embodiment used a filler neck 32 and a mating cap 28 to fill the bladder 22. There are other techniques of filling the bladder 22 with water 82. FIG. 4B presents a perspective view of a first alternate filler 40. As shown, instead of the filler neck 32 and the mating cap 28, the square base 90 uses a floating ball 46 that is enclosed within a ball cage 44. Downward displacement of the ball 46 enables filling the bladder 22 with water 82. When the ball 46 is released it rises against the ball cage 44, thereby closing the first alternate filler 40.

FIG. 4C presents a perspective view of a second alternate filler 50. According to filler 50, instead of the filler neck 32 and mating cap 28 the square base 90 incorporates a plurality of flexible flaps 54 that are attached to a rim 52 that is chemically bonded or welded to the square base 90. Water 82 filling is enabled by a downward displacement of the flaps 54 by a water supplying means, while removing the water supplying means allows closing of the second alternate filler 50 by action of the flaps 54 returning to their normal closed position. Water passing through the second alternate filler 50 fills the bladder 22.

FIG. 4D presents a perspective view of a third alternate filler 60. According to filler 60, instead of the filler neck 32 and mating cap 28, the square base 90 incorporates a flexible tube 62 that is permanently fastened onto an elbow 64, which in turn is permanently attached to the square base 90. Attachment of these elements can be performed using chemical bonding or welding. The flexible tube 62 extends horizontally to enable filling and is folded and secured by a clamp 66 to prevent leaking.

Refer now to FIGS. 4E and 4F for perspective views of a fourth alternate filler 70, which is depicted in a filling state in FIG. 4E and in the closed state in FIG. 4F. According to filler 70, instead of the filler neck 32 and mating cap 28, the square base 90 incorporates a flexible corrugated tube 72 which is attached to a flange 74, which is permanently fastened onto the top square base 90 using a technique such as chemical bonding or welding. FIG. 4E illustrates the corrugated tube 72 when it is extended vertically. The top surface portion of the square base 90 further includes an aperture 76. Filling takes place by filling water into the bladder 22 via the corrugated tube 72 when it is positioned as in FIG. 4 E. After filling, the fourth alternate filler 70 is closed by bending the corrugated tube 72 along a semi-circular direction and inserting its free end into the retaining aperture 76.

Therefore, it is to be understood that while the figures and the above description illustrate the present invention, they are exemplary only. They are not intended to be exhaustive or to limit the invention to the precise forms disclosed, and obviously many modifications and variations are possible in light of the above teaching. Others who are skilled in the applicable arts will recognize numerous modifications and adaptations of the illustrated embodiments that remain within the principles of the present invention. Therefore, the present invention is to be limited only by the appended claims.

What is claimed:

1. A plant pillow, comprising
a pyramid comprised of at least three transparent side panels;
a base having an inner surface facing said pyramid, an edge side for each of said side panels; and a surface opposed to said inner surface;
a plurality of flexible transitions connecting each of a said side panels to a mating edge side of said base, said flexible transitions for allowing said side panels to open said pyramid; and
a bladder for holding water, said bladder mating with said surface opposed to said inner surface,
wherein said base includes a filler for passing water into said bladder.

2. The plant pillow according to claim 1, wherein the base includes a central aperture.

3. The plant pillow according to claim 2, wherein said base further includes a slit that extends from said central aperture to a corner of said base.

4. The plant pillow according to claim 1, wherein each of said transparent panels is comprised of an external triangular frame, an internal triangular frame, and a transparent pane sandwiched between said external triangular frame and said internal triangular frame.

5. The plant pillow according to claim 1, wherein a first triangular frame includes a first tab having a downward facing slot and a second triangular frame includes a second tab having an upward facing slot.

6. The plant pillow according to claim 5, wherein said downward facing slot of said first triangle interlocks with said upward facing slot of said second triangle.

7. The plant pillow according to claim 1, wherein said filler comprises a threaded filler neck that is attached to said base and a removable mating cap.

8. The plant pillow according to claim 1, wherein said filler comprises a floating ball enclosed within a ball cage that is attached to said base.

9. The plant pillow according to claim 1, wherein said filler comprises a plurality of flexible flaps attached to a rim that is attached to said base.

10. The plant pillow according to claim 1, wherein said filler comprises a flexible tube fastened onto an elbow that is attached to said base.

11. The plant pillow according to claim 1, wherein said filler comprises a flexible corrugated tube and an aperture in said base, said flexible corrugated tube being attached at one end to said base via a flange that is attached to said base, and wherein a free end of said flexible corrugated tube fits into said aperture to prevent water loss.

12. The plant pillow according to claim 1, wherein said pyramid forms a greenhouse to heat water in said bladder.

13. The plant pillow according to claim 1, wherein said base is transparent.

14. The plant pillow according to claim 1, wherein said base and said panels are plastic.
